(19) United States
(12) Patent Application Publication
(10) Pub. No.: US 2014/0317372 A1
(43) Pub. Date: Oct. 23, 2014

(54) DATA FRAME SECURITY

(71) Applicant: Broadcom Corporation, Irvine, CA (US)

(72) Inventors: Jason William HERRICK, Pleasanton, CA (US); Hongtao ZHU, San Jose, CA (US)

(21) Appl. No.: 13/922,186

(22) Filed: Jun. 19, 2013

Related U.S. Application Data
(60) Provisional application No. 61/815,145, filed on Apr. 23, 2013.

(51) Int. Cl. G06F 12/14

(52) U.S. Cl. CPC G06F 12/14
USPC 711/163

(57) ABSTRACT

A method of securing a data frame is provided. The method includes receiving a request from a memory client to read or write decoded data in a memory. The memory may be partitioned to have a secure memory region and an unsecure memory region. The method also includes determining if the request is associated with the secure memory region or the unsecure memory region. The method also includes determining whether the memory client has access privileges to the secure memory region if the request is associated with the secure memory region. The method also includes granting the request if the memory client is determined to have access privileges.

### CROSS-REFERENCE TO RELATED APPLICATIONS

The present application claims the benefit of U.S. Provisional Patent Application Ser. No. 61/815,145, titled “DATA STREAM SECURITY,” filed on Apr. 23, 2013, which is hereby incorporated by reference in its entirety for all purposes.

### BACKGROUND

Transcoding systems are designed to convert an incoming data stream into a target format. The incoming data stream may be encoded and compressed. The transcoding process can decode the incoming data stream into data frames having an uncompressed format. The data frames may be exposed to software and/or hardware processes during the transcoding. As such, the exposure may leave data frames that require protection vulnerable.

Encryption techniques can be used to secure the data frames during the transcoding. Encryption works well when the amount of data is relatively small since decryption requires time and effort. Because the data frames in the uncompressed format can be significantly larger than compressed data, the latency resulting from applying encryption techniques may not be acceptable.

### SUMMARY

A system and/or circuit is provided for data frame security, substantially as illustrated by and/or described in connection with at least one of the figures, as set forth more completely in the claims.

### BRIEF DESCRIPTION OF THE DRAWINGS

Certain features of the subject technology are set forth in the appended claims. The accompanying drawings, which are included to provide further understanding, illustrate disclosed aspects and together with the description serve to explain the principles of the disclosed aspects. In the drawings:

FIG. 1 is a block diagram illustrating an example of an electronic system in accordance with one or more implementations.

FIG. 2 is a block diagram conceptually illustrating an example of a transcoder in accordance with one or more implementations.

FIG. 3 is a flowchart illustrating an example of a method for securing a data frame in accordance with one or more implementations.

FIG. 4 is a flowchart illustrating an example of a method for securing a data frame in accordance with one or more implementations.

FIG. 5 is a block diagram conceptually illustrating an example of a transcoder in accordance with one or more implementations.

FIG. 6 conceptually illustrates an electronic system with which any implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without one or more of these specific details. In one or more instances, structures and components are shown in block diagram form in order to avoid obscuring the concepts of the subject technology.

As briefly described above, a transcoding process can receive a compressed stream that is decoded into one or more data frames having an uncompressed format. In this regard, the data frame may be exposed during the transcoding process. In turn, the data frame may be left vulnerable to unwanted or unauthorized hardware and/or software processes. For example, a graphics processor may not need access to video pixel frames during the transcoding process but may request to read the video pixel frames from memory via a software process. Such processes may be manipulated to redirect the storage and/or presentation of the video pixel frames. In this respect, securing data frames in an uncompressed format during transcoding processes is desirable.

According to one or more aspects of the subject disclosure, a hardware and/or firmware implementation for securing a data frame during a transcoding process is provided. In addition, the subject disclosure discusses how data frames can remain secure when traversing an audio, video or data network. In this regard, the subject disclosure discusses how hardware and/or firmware elements of the network can ensure security of the data frame while reducing the need to encrypt the entire data frame or have software processes handle the security features of the data frame since software processes can become compromised.

In some implementations, a method of securing a data frame is provided. The method includes receiving a request from a memory client to read or write decoded data in a memory. The memory may be partitioned to have a secure memory region and an unsecure memory region. The method includes determining if the request is associated with the secure memory region or the unsecure memory region. The method includes determining whether the memory client has access privileges to the secure memory region if the request is associated with the secure memory region. The method also includes granting the request if the memory client is determined to have access privileges. In some aspects, by storing the data frame that needs to be protected in the secure memory region and having a memory controller control access to the secure memory region, the data frame may remain protected throughout the transcoding process without the need to encrypt the entire data frame, which can impact transcoding resources and performance.

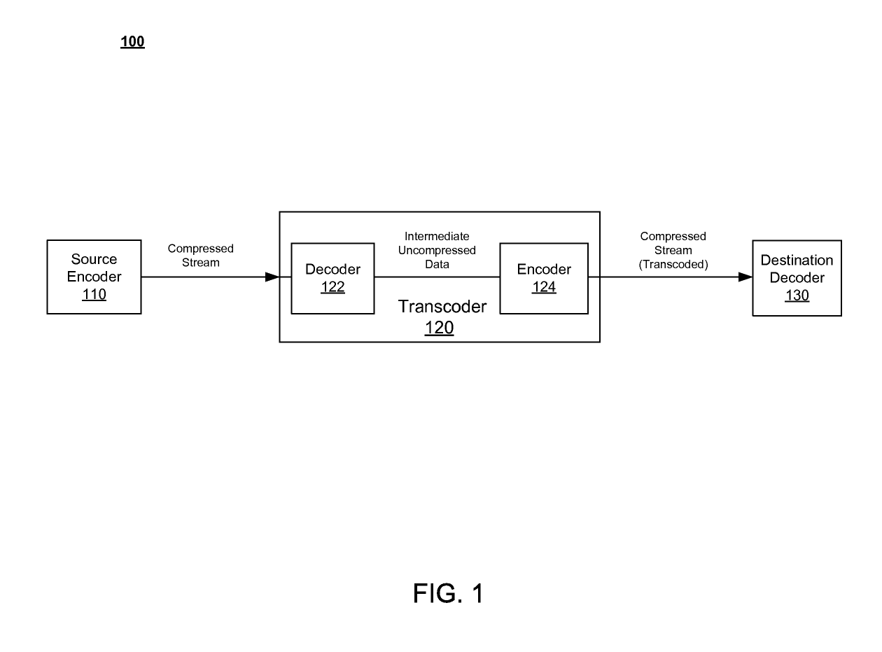

FIG. 1 is a block diagram illustrating an example of electronic system 100 in accordance with one or more implementations. Electronic system 100 includes source encoder 110, transcoder 120, and destination decoder 130. As shown in FIG. 1, transcoder 120 includes decoder 122 and encoder 124.

Source encoder 110 may include live video sources, video feeders, high definition digital visual interfaces, video encoders, live audio sources, audio feeders, high definition digital audio interfaces, and/or audio encoders. Transcoder 120 may include, but is not limited to, scalers, upscalers, decoders, encoders, compositors, de-interlacers, and other application specific data processing blocks. Destination decoder 130 may include checksum blocks that verify the validity of the transcoded data, capture blocks which may be used for storage or display, and audio or video decoders that may be used store and/or present a compressed stream in a specified format.

Transcoder 120 may be configured to digitally convert data from a source format to a target format. Transcoder 120 may be tasked to modify the data when destination decoder 130 does not support the source format, has limited storage that may require a smaller file size, or may require further editing of the data to improve performance. In one or more implementations, transcoder 120 may be configured to convert the data from a first video format (e.g., Movie Picture Expert Group (MPEG)-2) to a second video format (e.g., MPEG-4 or H.264) via decoder 122 and encoder 124. By way of illustration, the decoded data is modified to support the target format (e.g., H.264) and re-encoded in the target format. In some aspects, transcoder 120 may be configured to convert the data from a first audio format (e.g., Waveform Audio File “WAVE”) to a second audio format (e.g., MPEG-2 Audio Layer III “MP3”).

Decoder 122 may be configured to decode a compressed stream to create intermediate uncompressed data (or a data frame). In this respect, decoder 122 may be configured to decompress the compressed stream into a useable data frame. In some aspects, decoder 122 may be configured to decrypt the compressed stream before decompression if the compressed stream is encrypted. In this regard, decoder 122 may have access to a cipher text to decipher the encrypted stream. Alternatively, decoder 122 may be configured to decrypt the compressed stream after decompression.

In some implementations, the term “data frame” may sometimes refer to “decoded data” or “uncompressed data.” As used herein, the term “data frame” can include a video frame and/or a video field. The terms “video frame” and “video field” can include compressed or uncompressed video data depending on implementation. Video data may include two-dimensional video pixel data. In some aspects, the term “data frame” can include an audio frame. The term “audio frame” may include compressed or uncompressed audio data.

Encoder 124 may be configured to encode the data frame into a target format suitable for destination decoder 130. In addition, encoder 124 may compress the data frame into a transcoded compressed stream. In one or more implementations, encoder 124 may encrypt the data frame if destination decoder 130 requires security for display and/or storage.

In some aspects, electronic system 100 may include a switch to provide connectivity between source encoder 110, transcoder 120, and destination decoder 130. Other possible architectures may be provided where multiple switches may be used to allow more flexibility in the connection of transcoder 120 and where feedback paths may also be implemented.

Transcoder 120, as shown in FIG. 1, is positioned between source encoder 110 and destination decoder 130 as an intermediate node. In some aspects, transcoder 120 may be collocated with a display device and may therefore act as a destination decoder. In one or more implementations, decoder 122 and encoder 124 of transcoder 120 may be in separate units and may span two separate nodes.

In some aspects, transcoding functions may require that at least one prior video field or video frame be stored to carry out data transmission or display operations. For example, electronic system 100 may be a video system that uses a reference frame for prediction encoding. Electronic system 100 may transmit the reference frame in a different order from its display order, requiring some form of local buffering (or intermediate buffering) for the reference frame in addition to an administrative function that tracks changes in the mode of operation when transcoder 120 encodes and/or transfers video data sequences. Because the reference frame may be in an uncompressed format, and thus, exposed to hardware and/or software processes, the reference frame may be left vulnerable to unwanted or unauthorized access by the aforementioned processes during the prediction encoding. As such, security of the reference frame without unnecessary encryption of the entire reference frame is desirable.

Video encoding standards such as MPEG-2, ITU-H.264 (also known as MPEG-4, Part 10 and Advanced Video Coding) use motion compensation for compressing video data comprising a series of pictures. As such, results from prior motion compensation processes can be used by encoder 124 to supplement current motion compensation processes in generating a transcoded compressed stream. In this regard, the results may be vulnerable to unwanted or unauthorized software processes during the motion compensation process, for example. As such, protecting the results in a manner that can avoid encrypting all of the results is desirable. As will be discussed in further detail, providing security to data frames left vulnerable to unauthorized software processes, for example, can be addressed by storing the data frames in a secure memory region.

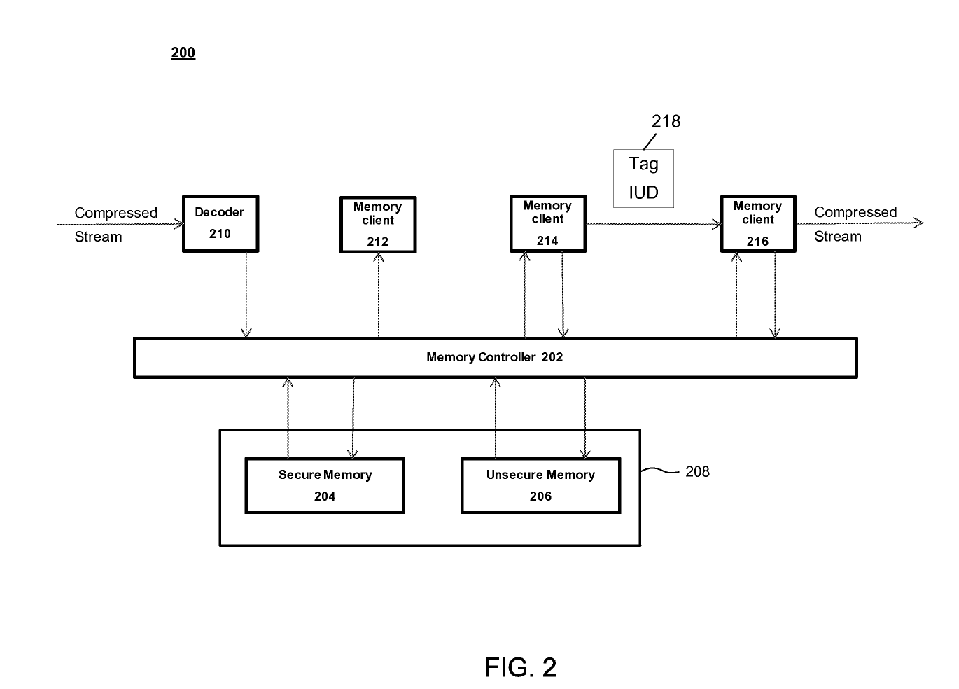

FIG. 2 is a block diagram conceptually illustrating an example of transcoder 200 in accordance with one or more implementations. Transcoder 200 includes memory controller 202, memory 208, decoder 210, memory clients 212, 214 and 216. As shown in FIG. 2, memory 208 includes secure memory 204 and unsecure memory 206. Transcoder 200 is configured to receive an input compressed stream and supply an output compressed stream that is a transcoded version of the input compressed stream. As used herein, the terms “secure memory” and “a secure region of a memory” do not imply any particular tangible or intangible modification of a subject, but rather are intended to be used interchangeably.

The input compressed stream may represent an audio and/or video program such as, for example, a television show, a movie, a song, or an audio book. To this end, the input compressed stream may be a program transmitted to a set-top box (STB) over a wired network. Alternatively, the input media file may be a program transmitted to the STB over a wireless network (e.g., broadcast network, multicast network, unicast network, Wi-Fi, Bluetooth™).

The output compressed stream may express the same substantive content as the input compressed stream. Alternatively, the output compressed stream may express a subset of the content of the input compressed stream. However, the output compressed stream may be encoded in a format that differs from the format of the input compressed stream. A different format of the output compressed stream may conform to the same standard as the input compressed stream while having a different bit rate or file size.

In one or more implementations, the output compressed stream may be fed to a media device (not shown) for storage and/or display. A media device may include, but is not limited to, a laptop computer, desktop computer, notepad, notebook, ultrabook, tablet, cellular telephone, personal digital assistant (PDA), STB, digital camera, portable media player, or any other electronic device configured to playback a compressed stream.

Memory controller 202 may be configured to receive requests from memory clients 210, 212, 214 and 216 to read from memory 208 and/or write to memory 208. Memory controller 202 may look at the address space of a memory transaction (e.g., read/write access request) to determine if the received request refers to secure memory 204 or unsecure memory 206. By way of illustration, the start and end address range may fall within the address space of secure memory 204. As such, memory controller 202 treats the memory request as a request to access secure memory 204. Similarly, if the address range in the memory request falls within the address space of unsecure memory 206, memory controller 202 treats the memory request as a request to access unsecure memory 206.

Memory 208 may be partitioned into secure memory 204 and unsecure memory 206. In some aspects, decoded data not requiring security may be written into unsecure memory 206. However, decoded data that requires security may only be stored in secure memory 204. Secure memory 204 may be configured to provide random access. In some aspects, secure memory 204 may be partitioned to have one or more secure regions where each secure region is associated with a respective context.

Non-limiting examples of memory 208 include, but are not limited to, random access memory (RAM) including, for example, static random access memory (SRAM) and dynamic random access memory (DRAM), or magnetic random access memory (MRAM), USB flash drives, magnetic hard drives, memory cards, solid-state drives or optical discs. In addition, memory 208 may include a read-only memory (ROM), a programmable read-only memory (PROM), an erasable programmable read-only memory (EPROM), an electrically erasable programmable read-only memory (EEPROM), or other type of memory device having persistent memory with controlled access.

A memory request to read memory may include a start address and an end address. By way of illustration, data returned from a read operation can include a video frame containing two-dimensional video pixel data. When data is read, memory controller 202 may return a tag (or an indication) to the requesting memory client with the data that was read. The data read may come from secure memory 204. Alternatively, the data read may come from unsecure memory 206. In some aspects, the tag can be used by the requesting memory client to determine if the data read came from secure memory 204 or unsecure memory 206. In one or more implementations, the tag may be generated by memory controller 202.

As used herein, the term “data” may sometimes refer to a “data frame” for simplicity of explanation and is not intended as a tangible or intangible modification of the feature. A requesting memory client can sometimes be referred to one of memory clients 212, 214 and 216 that can send a memory request to memory controller 202.

In one or more implementations, memory clients 212, 214 and 216 are given access to write memory into secure memory 204. If data to be written into secure memory 204 is tagged to be secured, memory clients 212, 214 and 216 notify memory controller 202 that the written data is secured. As such, memory controller 202 may verify that all written data marked as “secure,” for example, is stored into the correct address space associated with secure memory 204.

A memory request to write memory may include a start address and an end address. A request to write to memory may include a tag (or indication) from the requesting memory client to memory controller 202 describing if the written data should be stored in secure memory 204. In some aspects, decoder 210 may create the tag based on properties of the input compressed stream. In one or more implementations, the requesting memory client may create the tag based on a tag returned from a prior memory read.

In some implementations, the requesting memory client may create the tag based on data received directly from a neighboring (or upstream) memory client. By way of illustration, memory client 216 may request to write to secure memory 204, and creates a tag based on data received from memory client 214.

In one or more implementations, the tag can specify that the data should be protected (or be stored in secure memory). If the tag specifies that the data must be placed into secure memory 204, then the data will not be written into unsecure memory 206. In this respect, memory controller 202 is configured to control read/write access to secure memory 204 based on the memory requests.

As shown in FIG. 2, decoder 210 receives the input compressed stream on a transcoding path. The compressed stream may be encrypted with a cipher text. Decoder 210 decodes the compressed stream to create a data frame. In some aspects, the data frame may be in a raw format (or plain text). Depending on implementation, the data frame may contain a video frame, for example. In this respect, the video frame may contain video pixel data. Alternatively, the data frame may contain an audio frame, for example.

Decoder 210 may detect that the incoming compressed stream requires security by receiving an indication from source encoder 110 (FIG. 1) that the incoming compressed stream should be protected. Rather than encrypting the entire data frame, the data frame may be secured by virtue of being stored in a secure region of memory (e.g., secure memory 204). In this respect, decoder 210 may request memory controller 202 to store the data frame into secure memory 204.

In some aspects, decoder 210 may read a compressed stream from secure memory 204. In this regard, the compressed stream may have been stored by a memory client into secure memory 204 to denote that the compressed stream requires security (or protection). As such, decoder 210 may be configured to decode the read compressed stream from secure memory 204 and handle the decoded data as data deriving from secure memory 204 (including tagging the decoded data to notify memory clients downstream that the decoded data requires protection).

Memory clients 212, 214 and 216 may be configured as, but are not limited to, scalers, upscalers, decoders, encoders, compositors, de-interlacers, and other application specific data processing clients. In this respect, memory clients 212, 214 and 216 may make memory requests to memory and may convert the received data into other formats. By way of illustration, memory clients 212, 214 and 216 may read field data and produce frame data. Alternatively, memory clients 212, 214 and 216 may read video frames and produce scaled frame data or image enhancement. In addition, memory clients 212, 214 and 216 may read data and produce a compressed bit stream. In one or more implementations, memory clients 212, 214 and 216 may include a central-processing unit (CPU), graphic cores and/or direct memory access (DMA) engines.

In some aspects, memory clients 212, 214 and 216 may be allowed access to secure memory 204. In some aspects, memory clients 212, 214 and 216 may be blocked access to secure memory 204. To determine which memory clients may be blocked, memory controller 202 may determine if memory clients 212, 214 and 216 have access privileges to secure memory 204. In turn, memory controller 202 may compare an identifier associated with memory clients 212, 214 and 216 against an access list (or access table) that indicates which memory clients can request to have data read from and/or written to secure memory 204.

Memory controller 202 may be configured to determine if the requesting memory client having data that is tagged to be protected via secure memory 204 has access privileges to have the data written into secure memory 204. Memory controller 202 may load the access list that indicates which memory clients have access privileges to secure memory 204. Memory controller 202 may be configured to search the access list for a match. If memory controller 202 locates the requesting memory client in the access list, then memory controller 202 can allow the requesting memory client access to a data frame stored in secure memory 204. If memory controller 202 cannot locate the requesting memory client in the access list, then memory controller 202 denies the requesting memory client access to secure memory 204. In turn, memory controller 202 may not return any data to the requesting memory client.

In one or more aspects, the access list may be burned into hardware. That is, the access list may be stored in read-only memory, and may not be changed or altered by memory controller 202 or any other components requesting memory access to secure memory 204.

To locate the requesting memory client in the access list, memory controller 202 may be configured to retrieve, from the memory request, an identifier associated with the requesting memory client. In this respect, memory controller 202 may compare the identifier against the one or more memory clients indicated in the access list. Memory controller 202 can grant access to the requesting memory client if the identifier matches one of the one or more memory clients identified in the access list.

Although decoder 210 may have access privileges to secure memory 204, a central processing unit (CPU), for example, may not have access privileges to secure memory 204 since the CPU does not need access to video pixel data. As such, the CPU may not be identified in the access list. Alternatively, the CPU may be identified in the access list with an indication to restrict access to the CPU.

During operation, memory clients 212 and 214 may be configured to process the output of decoder 210. For transcoder 200 implemented as a video transcoder, memory client 214, for example, may be a pixel processor that may perform pixel processing functions. In one or more aspects, memory client 214 can request memory access to and from secure memory 204. As will be discussed in further detail below, memory client 214 may be granted access to secure memory 204 if memory client 214 has access privileges.

Non-limiting examples of pixel processing are picture size adjustment, interlacing/de-interlacing, color space conversion, noise reduction, and image enhancement. Pixel processing may include changing a format. In one or more aspects, a format change may be high definition (HD) conversion, standard definition (SD) conversion, 2-channel conversion, or de-interlacing. After memory client 214 receives and processes the data frame, memory client 214 sends the processed data frame to memory client 216.

Memory client 216 may act as an encoder and be configured to encode the data frame to a target format. By way of illustration, memory client 216 converts uncompressed pixel data into a compressed bit stream (e.g., same type as the input compressed stream to decoder 210). In one or more aspects, memory client 216 can request memory access to and from secure memory 204. Memory client 216 can use the tag returned with data read from secure memory 204 to determine if the output compressed stream needs to be encrypted before arriving at destination decoder 130 (FIG. 1), for example.

In some aspects, the tag may be forwarded by memory client 214. As shown in FIG. 2, memory client 214 may forward (e.g., intermediate uncompressed data (IUD) 218) to memory client 216 along a downstream path. Here, memory client 214 can include a tag associated with IUD 218. In some aspects, the tag may be located in an overhead portion of IUD 218.

In one or more aspects, memory client 216 may create the tag to notify memory controller 202 during a write operation that the data should be protected in memory. Memory client 216 may create the tag for the data to be written into secure memory 204 based on data received from memory client 214. As will be discussed in further detail below, memory client 216 may be granted access to secure memory 204 if memory client 216 is determined, by memory controller 202, to have access privileges.

Memory client 216 may use other techniques, including encryption, to secure the output compressed stream. In this respect, the tag used by memory client 216 may not be forwarded to destination decoder 130 (FIG. 1) or may not be included within the output compressed stream. In some aspects, memory client 216 may be configured to store the output compressed stream into secure memory 204. In this respect, memory client 216 tags the output compressed stream and requests memory controller 202 to store the tagged compressed stream into secure memory 204. In turn, decoder 210, in a subsequent memory read request, may request memory controller 202 to read the output compressed stream from secure memory 204.

When memory controller 202 allows the requesting memory client access to read from secure memory 204, memory controller 202 may mark IUD 218 with an indication that IUD 218 derived from secure memory 204. In this respect, an overhead portion of IUD 218 may be written with the indication. The indication may include one or more bits of information to inform memory clients 212, 214 and 217 located on a downstream path from memory controller 202 that IUD 218 should either be written only to secure memory 204 or include the tag throughout the downstream path to indicate that IUD 218 is derived from secure memory 204. In this respect, memory clients 212, 214 and 216 are responsible to forward the tag along the downstream path. By way of illustration, if memory client 214 reads from secure memory 204, memory client 214 may forward the tag to memory client 216 to indicate to memory client 216 that the data frame (e.g., IUD 218) should be stored back into secure memory 204 or be encoded with security in the compressed stream.

In one or more aspects, transcoder 200 is implemented as a microprocessor. Transcoder 200 may include one or more circuits, one or more microprocessors, or any combination thereof. To this end, transcoder 200 may be implemented by one circuit and/or microprocessor or may be implemented by multiple circuits and/or microprocessors such that the functionality of transcoder 200 is distributed across one or more circuits and/or one or more microprocessors.

In some implementations, transcoder 200 may include one or more hardware and/or firmware modules operable within one or more processing circuits. Transcoder 200 may further include a computer-readable medium. The computer-readable medium may store instructions and/or code to cause transcoder 200 to transcode portions of the input media file.

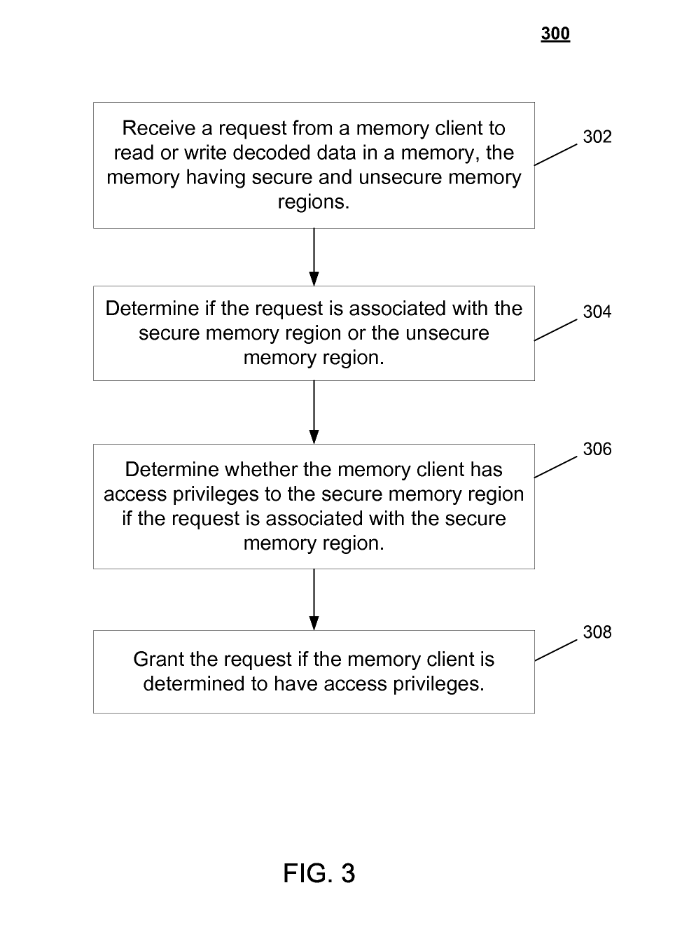

FIG. 3 is a flowchart illustrating an example of a method 300 for securing a data frame in accordance with one or more implementations. Method 300 may be implemented in transcoder 200 (FIG. 2) such that decoded data in an uncompressed format from decoder 210 can be secured without encrypting the data frame in its entirety. In this respect, method 300 may be performed by memory controller 202 that is communicatively coupled to one or more memory clients (e.g., memory clients 212, 214 and 216) and secure memory 204. The steps or processes discussed with respect to FIG. 3 are not limited to those shown, and may include more or less steps to secure a data frame.

Method 300 includes receiving a request from a memory client to read or write decoded data in a memory, wherein the memory comprises a secure memory region and an unsecure memory region (302). Method 300 also includes determining if the request is associated with the secure memory region or the unsecure memory region (304). In determining if the request is associated with the secure memory region or the unsecure memory region, method 300 also includes obtaining an address included in the request to determine if the address is within the secure memory region. Method 300 also may include determining whether the decoded data is marked with an indication that the decoded data is to be secured in the secure memory region when determining whether the request is associated with the secure memory region or the unsecure memory region.

Method 300 also includes determining whether the memory client has access privileges to the secure memory region if the decoded data is to be secured in the secure memory region based on the request (306). In determining whether the memory client has access privileges, method 300 can include obtaining a table of memory clients that determines permissions to the secure memory region.

Method 300 also includes granting the request if the memory client has access privileges (308). Alternatively, method 300 may include denying the request if the request is associated with the unsecured memory region and the decoded data is marked with the indication to secure the decoded data in the secure memory region. After granting the request, method 300 may include providing an indication to the memory client with data read from the secure memory region to indicate to the memory client that the data is to be secured in the secure memory region. This will notify the memory client that the read data can only be stored in the secure memory region. As such, the memory client can include a tag to be forwarded to other memory clients located downstream.

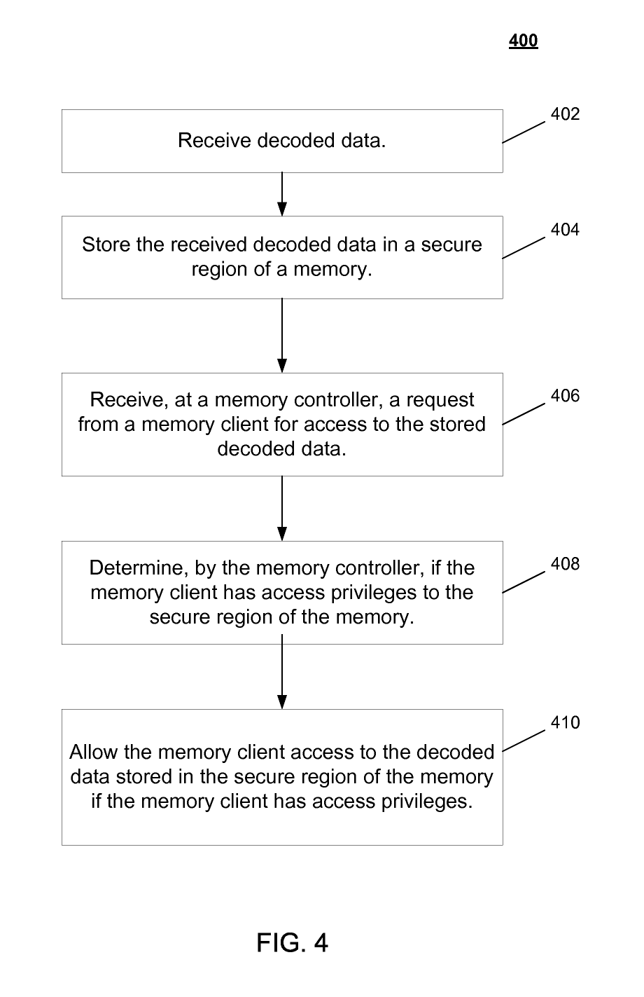

FIG. 4 is a flowchart illustrating an example of method 400 for securing a data frame in accordance with one or more implementations. Method 400 may be implemented in transcoder 200 (FIG. 2) such that decoded data in an uncompressed format (or data frame) from decoder 210 can be secured without the need to encrypt the data frame in its entirety. In this respect, method 400 may be performed by memory controller 202 that is communicatively coupled to one or more memory clients (e.g., memory clients 212, 214 and 216) and secure memory 204. The steps or processes discussed with respect to FIG. 4 are not limited to those shown, and may include more or less steps to secure a data frame.

Method 400 includes receiving decoded data (402). As noted above, the decoded data can sometimes be referred to as a data frame. Decoder 210 can receive an input compressed stream. Decoder 210 can then decode and decompress the input compressed stream to provide the decoded data. Decoder 210 may then request memory controller 202 to write the decoded data into memory.

In some aspects, the input compressed stream may be encoded with a cipher text (e.g., encrypted compressed stream). In receiving the input compressed stream, decoder 210 may be configured to access an overhead portion of the input compressed stream. As such, the overhead portion may be located in a front portion of the input compressed stream that provides advance notification relating to the decoded data. The advance notification may inform decoder 210 that the decoded data should be kept secure in memory. In some aspects, the advance notification may be located in a payload portion of the decoded data. As such, the indication (or tag) may be co-located with video pixel data, for example.

The overhead portion of the input compressed stream may include an indication that informs decoder 210 that the decoded data can only be written into secure memory 204. In one or more aspects, the indication may be overhead signaling, a tag, or a flag that is composed of a single binary bit or multiple bits (e.g., binary, hexadecimal, characters). The overhead portion may be marked to denote different contexts or provide embedded rules for destination memory clients.

By way of illustration, the decoded data requiring security may relate to service provider content (e.g., subscription audio or video channel, pay-per-view content, enhanced streaming video or audio content). As such, the service provider may request that the decoded data not be accessible by unauthorized memory clients (e.g., a software module, a central processing unit, a graphics processor, a DMA engine). The service provider request may be expressly or implicitly provided in the overhead portion of the input compressed stream (or decoded data) depending on implementation.

In some aspects, a memory may be partitioned into a single or multiple regions of secure memory. As will be discussed in further detail below, each of the secure regions may be assigned to a respective context. A context may refer to the content type, security type, subscription status, format type, or destination type of the decoded data. In some implementations, the entire address space of secure memory 204 may be reserved for only data tagged to be secured.

In assigning each of the secure regions to the respective context, each of the secure regions may be mapped to an identifier that indicates that the secure region is associated with the respective context. In some implementations, secure memory 204 can be partitioned into multiple secure regions. In one or more aspects, only a single memory controller may be implemented to control access to the one or more secure regions. Alternatively, multiple memory controllers may be implemented such that each memory controller is assigned to a respective one of the secure regions.

Method 400 also includes storing the received decoded data in a secure region of memory (404). In one or more aspects, the decoded data may be transmitted as packets, frames, blocks, or segments of data. If the decoded data is composed of one or more segments, for example, decoder 210 may designate the one or more segments of data to the same secure region of memory (e.g., secure memory 204). In this respect, the entire decoded data is written into one secure region of memory.

In one or more aspects, memory controller 202 may receive multiple blocks of decoded data at different times. In this respect, decoder 210 may determine if the decoded blocks of data are associated with different contexts. If each of the decoded blocks of data belong to a different context (e.g., one decoded block of data relates to a 720p video format, another decoded block of data relates to a 1080p video format), then decoder 210 can designate each of the decoded blocks of data to a different secure region of memory associated with the respective context. In this regard, memory controller 202 makes sure that each decoded block of data is stored in the proper secure region of memory. To do so, memory controller 202 may access different address spaces within secure memory 204 that correspond to a respective context.

In storing the decoded data, memory controller 202 may be configured to determine if the decoded data relates to a context. Upon receiving the memory request, memory controller 202 may determine if the memory request comprises an indication of the context. In one or more aspects, the decoded data may relate to one or more contexts. If the decoded relates to a specific context, then memory controller 202 may be configured to make sure that the data associated with the specific context is stored in the proper address space within secure memory 204.

Method 400 also includes receiving, at memory controller 202, a request from a memory client for access to the stored decoded data (406). Method 400 also includes determining, by memory controller 202, if the memory client has access privileges to secure memory 204 (408).

By way of illustration without limiting the scope of the subject disclosure, memory controller 202 may receive a memory request to store the data frame into secure memory 204. In this respect, memory client 214 sends a memory request to memory controller 202 to write to secure memory 204. The memory request may be tagged to notify memory controller 202 that the data to be written is to be kept secured. As such, memory controller 202 may determine if memory client 214 has access privileges by first loading an access list that identifies one or more memory clients determined to be secure and then searching the access list. In this respect, the access list may contain identifiers associated with the one or more memory clients such that memory controller 202 may compare the identifiers provided in the access list with an identifier, associated with memory client 214, obtained via the memory request. If there is a match, memory controller 202 can grant the memory request and allow the memory client 214 access to write the data frame into secure memory 204.

After accessing the access list, memory controller 202 may set registers located therein that allow the one or more memory clients identified in the access list access to secure memory 204. In this respect, memory controller 202 may avoid having to spend processing time to look up the identifier of the requesting memory client in the access list each time. Alternatively, memory controller 202 may be configured to access the access list as a lookup during each memory request. The access list may be stored in persistent (or read-only) memory that is located within or external to memory controller 202. In this respect, the access list may not be modified or altered by memory controller 202 or any components associated with memory requests to secure memory 204. The access list may be pre-configured by the manufacturer or at startup of transcoder 200.

Method 400 also includes granting the memory client access to the decoded data stored in secure memory 204 if the memory client has access privileges (310). In this respect, the decoded data may be written into secure memory 204 or read out from secure memory 204. The read data may be tagged by memory controller 202 to denote that the read data derived from secure memory 204. The written data may be tagged by the requesting memory client or by decoder 210 in a prior transaction to denote that the data is to be kept secured. Memory controller 202 may be configured to verify that memory requests to secure memory 204 are made to the proper address space within secure memory 204.

When data is read out from secure memory 204, memory controller 202 may write to the overhead portion of the read data to indicate that the read data belongs to/in or originates from secure memory 204. This indication may be intended to notify memory clients that receive the read data. Memory controller 202 may verify the decoded data that is stored in secure memory 204 when processing the read request. In some aspects, memory controller 202 can verify that the decoded data is written into the correct secure region if multiple secure regions associated with respective contexts are present in secure memory 204. In this regard, if the decoded data contains the indication, then memory controller 202 can check that the decoded data is stored within the expected address space. If decoded data that is tagged is not stored within the expected address space of secure memory 204, then memory controller 202 may output a flag indicating a memory access violation. In this respect, no data may be read out from secure memory 204.

By way of illustration without limiting the scope of the subject disclosure, a data frame may be associated with a first context. When memory controller 202 provides memory client 212 read access to secure memory 204 to retrieve the data frame, memory controller 202 may be configured to output a flag indicating a violation if the read data frame is stored in one of the secure regions associated with a second context. In this respect, no data frame will be read out to memory client 212.

In one or more aspects, secure memory 204 may be converted from secure memory into unsecure memory, and vice versa. As a result of the conversion, secure memory 204 may be initialized to ensure that any data, in an uncompressed format, is not accessible after conversion. In some aspects, one or more secure regions of memory associated with a respective context may be initialized if the one or more secure regions has a data frame associated with a different context.

Memory clients may be configured to make memory requests to access secure memory 204. The memory clients may be implemented in only hardware such that certain circuit configurations can logically process rules that keep the decoded data secure while undergoing one or more transcoding processes. In this respect, other memory clients not allowed to access the decoded data tagged to be secure will be blocked by hardwired rules. The memory client also may be configured by only firmware such that non-volatile computer-readable media included in the memory client can store instructions and process the stored instructions without interaction or interruption by one or more software processes or modules. The memory client also may be configured using a combination of only hardware and firmware components.

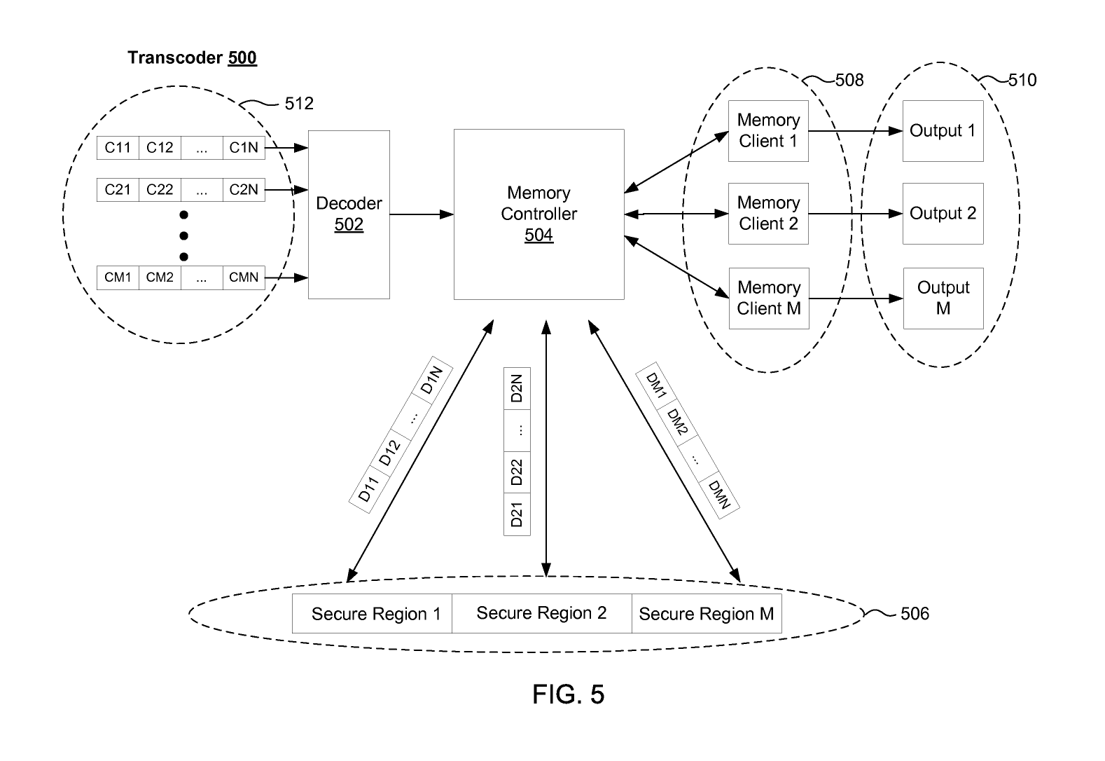

FIG. 5 is a block diagram conceptually illustrating an example of transcoder 500 in accordance with one or more implementations. Transcoder 500 includes decoder 502, memory controller 504, memory 506 and memory clients 508. Transcoder 500 may be configured to output a compressed stream to output devices 510.

In some aspects, decoder 502 may receive multiple compressed streams 512 on a transcode path. The compressed streams 512 may be encrypted with a respective cipher text or the same cipher text. Compressed streams 512 may be composed of frames, segments or packets. Each packet may be identified to denote a location within the stream and an identification of the stream (e.g., C11, C22). By way of illustration, a packet identified as C11 denotes that the packet is the first packet in the stream and belongs to the first stream. Similarly, a packet identified as C22 denotes that the packet is the second packet in the stream and belongs to the second stream.

Decoder 502 can decode each of the compressed streams into a respective set of data frames as uncompressed data. The compressed streams 512 may be composed of one or more segments, packets, frames, chunks, or blocks of data. Each may be processed individually or collectively by decoder 502 and/or memory controller 504. Similar to above, each piece of decoded data (or data frame) may be identified to denote a location of the data frame within a respective compressed stream and an identification of the respective compressed stream (e.g., D11, D22). As such, a data frame identified as D11 denotes that the data frame is the first piece of data in the compressed stream and belongs to the first compressed stream, while a data frame identified as D22 denotes that the data frame is the second piece of data within the compressed stream and belongs to the second compressed stream. In some aspects, there may be M streams containing N data frames, where M and N are positive integers.

In some aspects, decoder 502 can detect that each of the incoming compressed streams 512 may require security. Rather than encrypting the entire data frame from decoder 502, each data frame may be tagged to notify memory controller 504 that the data frame is to be kept secured in a secure region of memory 506. That is, the data frame can be stored only in the secure regions of memory 506. Decoder 502 may provide an indication within a memory request to store the data frame in the secure region of memory 506. In some aspects, the indication may be included within an overhead portion of the data frame, for example.

As shown in FIG. 5, memory 506 may be partitioned into secure region 1, secure region 2, and secure region M. Each secure region of memory 506 may be defined by a respective address space (e.g., start and end address range). Alternatively, memory 506 may be partitioned with secure and unsecure regions of memory.

One of the set of data frames from decoder 502 may be stored in secure region 1, while a second set of data frames may be stored in secure region 2, and a third set of data frames may be stored in a third secure region (e.g., where M=3). In this respect, each of the set of data frames may be associated with a memory request requesting to store the corresponding data frames in a respective address space. In one or more aspects, the different sets of data frames may be stored in the same secure region of memory 506.

In some aspects, the secure regions of memory 506 may correspond to different contexts or different levels of security. In one or more aspects, the secure regions of memory 506 may be associated with a different output device requiring specific security features or contexts. By way of illustration without limiting the scope of the subject disclosure, secure region 1 of memory 506 may be read by memory client 2 to process and forward a tagged data frame for display via output 2. In this respect, output 2 may support security features that are needed to process the read data from region 1 of memory 506 (e.g., output 2 is a high-definition multimedia interface (HDMI) output with high-bandwidth digital content protection (HDCP)). That is, memory client 2 may encrypt the tagged data frame if memory client 2 is an encoder. Alternatively, secure region 2 of memory 506, for example, may contain data that can be read and output via any one of output devices 510 based on the security requirements or context of the read data.

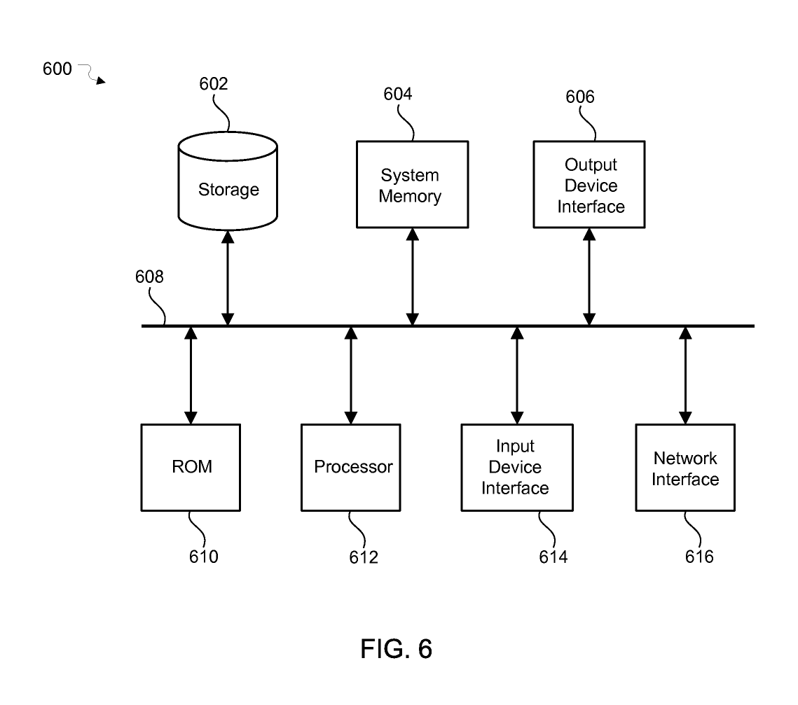

FIG. 6 conceptually illustrates electronic system 600 with which implementations of the subject technology may be implemented. Electronic system 600, for example, can be a set-top box, or generally any electronic device that receives and transcodes signals over a network as an intermediate node (or a node communicatively coupled between endpoints). Such an electronic system includes various types of computer readable media and interfaces for various other types of computer readable media. Electronic system 600 includes bus 608, processing unit(s) 612, system memory 604, read-only memory (ROM) 610, permanent storage device 602, input device interface 614, output device interface 606, and network interface 616, or subsets and variations thereof

Referring to FIG. 6, bus 608 collectively represents all system, peripheral, and chipset buses that communicatively connect the numerous internal devices of electronic system 600. In one or more implementations, bus 608 communicatively connects processing unit(s) 612 with ROM 610, system memory 604, and permanent storage device 602. From these various memory units, processing unit(s) 612 retrieves instructions to execute and data to process in order to execute the processes of the subject technology. The processing unit(s) can be a single processor or a multi-core processor in different implementations.

ROM 610 stores static data and instructions that are needed by processing unit(s) 612 and other modules of the electronic system. ROM 610 may be configured to store an access list that provides a listing of memory clients having access privileges to one or more secure regions of memory. Permanent storage device 602, on the other hand, is a read-and-write memory device. This device is a non-volatile memory unit that stores instructions and data even when electronic system 600 is off. One or more implementations of the subject technology use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such as random access memory. System memory 604 stores any of the instructions and data that processing unit(s) 612 needs at runtime. In one or more implementations, the processes of the subject technology are stored in system memory 604, permanent storage device 602, and/or ROM 610. From these various memory units, processing unit(s) 612 retrieves instructions to execute and data to process in order to execute the processes of one or more implementations.

Bus 608 also connects to input and output device interfaces 614 and 606. Input device interface 614 enables a user to communicate information and select commands to the electronic system. Input devices used with input device interface 614 include, for example, alphanumeric keyboards and pointing devices (also called “cIUDor control devices”). Output device interface 606 enables, for example, the display of images generated by electronic system 600. Output devices used with output device interface 606 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, bus 608 also couples electronic system 600 to a network (not shown) through network interface 616. In this manner, the computer can be a part of a network of computers (such as a local area network (“LAN”), a wide area network (“WAN”), or an Intranet, or a network of networks, such as the Internet. Any or all components of electronic system 600 can be used in conjunction with the subject technology.

Many of the above-described features and applications may be implemented as firmware processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions.

Examples of computer-readable media include, but are not limited to, read-access memory (RAM), read-only memory (ROM), magnetic and/or solid state hard drives, ultra density optical discs, any other optical or magnetic media, and floppy disks. In one or more implementations, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more implementations, the computer-readable media is non-transitory computer-readable media, computer-readable storage media, or non-transitory computer-readable storage media.

In one or more implementations, a computer program product (also known as a program, firmware, firmware application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute firmware, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer firmware, or combinations of both. To illustrate this interchangeability of hardware and firmware, various illustrative blocks, modules, elements, components, methods, and algorithms have been described above generally in terms of their functionality. Whether such functionality is implemented as hardware or firmware depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single firmware product or packaged into multiple firmware products.

As used in this specification and any claims of this application, the terms “mobile device”, “set-top box”, “computer”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. Such disclosure may provide one or more examples. A phrase such as an aspect may refer to one or more aspects and vice versa, and this applies similarly to other phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method of securing a data frame, the method comprising:
receiving a request from a memory client to read or write a data frame in a memory, wherein the memory comprises a secure memory region and an unsecure memory region;
determining if the request is associated with the secure memory region or the unsecure memory region
determining whether the memory client has access privileges to the secure memory region if the request is associated with the secure memory region; and
granting the request if the memory client is determined to have access privileges.

2. The method of claim 1, wherein determining if the request is associated with the secure memory region or the unsecure memory region comprises determining if an address, included in the request, is within an address range associated with the secure memory region.

3. The method of claim 1, wherein determining if the request is associated with the secure memory region or the unsecure memory region comprises determining whether the data frame is marked with an indication that the data frame needs protection if the request is a write request.

4. The method of claim 3, further comprising:
denying the request if the request is associated with the unsecured memory region and the data frame is marked with the indication to secure the data frame in the secure memory region.

5. The method of claim 1, further comprising:
providing an indication to the memory client when the request is a read request to indicate to the memory client that the data frame needs to be secured in the secure memory region for subsequent memory write requests.

6. The method of claim 1, further comprising:
marking the data frame with an indication that the data frame needs to be secured in the secure memory region when the data frame is read from the secure memory region in response to the request.

7. A method of securing a data frame comprising:
receiving a write request to store a data frame;
receiving the data frame;
storing the data frame in a secure region of a memory;
receiving, at a memory controller, a read request from a memory client for access to the stored data frame;
determining, by the memory controller, if the memory client has access privileges to the secure region of the memory; and
allowing the memory client access to the data frame stored in the secure region of the memory if the memory client is determined to have access privileges.

8. The method of claim 7, further comprising:
reading the data frame from the secure region of the memory in response to the read request; and
marking the read data frame with an indication that the data frame needs to be stored in the secure region of the memory for subsequent memory write requests.

9. The method of claim 8, wherein marking the read data frame comprises providing the indication in an overhead portion of the data frame.

10. The method of claim 8, wherein marking the read data frame comprises providing the indication in a payload portion of the data frame.

11. The method of claim 7, further comprising:
accessing an overhead portion of the write request;
determining if the overhead portion comprises an indication of a context; and
accessing an address space of the secure region of the memory that corresponds to the context to store the data frame.

12. The method of claim 7, wherein the memory is partitioned into a plurality of secure regions, the method further comprising associating each of the plurality of secure regions with a respective context.

13. The method of claim 12, further comprising:
initializing at least one of the plurality of secure regions associated with the respective context if the at least one of the plurality of secure regions contains a data frame associated with a different context.

14. The method of claim 13, further comprising:
outputting a flag indicating a violation if the data frame that is stored in one of the plurality of secure regions is associated with the different context.

15. The method of claim 7, wherein determining if the memory client has access privileges comprises:
loading an access list that identifies one or more memory clients determined to be secure; and
comparing the memory client against the access list to determine a match,
wherein the memory client is granted access if there is a match.

16. The method of claim 15, wherein determining if the memory client has access privileges comprises comparing an identifier of the memory client against the access list to determine a match between the access list and the identifier.

17. The method of claim 7, further comprising:
receiving a plurality of data frames to store in the secure region of the memory;
determining if the plurality of data frames are associated with different contexts; and
accessing different address spaces within the secure region of the memory that correspond to a respective context.

18. A non-transitory machine-readable medium embodying instructions that, when executed by a machine, cause the machine to perform a method of securing a data frame, the method comprising:
receiving a request from a memory client to read or write a data frame in a memory, wherein the memory comprises a secure memory region and an unsecure memory region;
determining if the request is associated with the secure memory region or the unsecure memory region;
determining whether the memory client has access privileges to the secure memory region if the request is associated with the secure memory region; and
granting the request if the memory client is determined to have access privileges.

19. A transcoding system comprising:
a memory comprising a secure memory region and an unsecure memory region;
a plurality of memory clients configured to convert a data frame from a first format to a second format; and
a controller coupled to the plurality of memory clients and the memory, the controller configured to:
receive a request from one of the plurality of memory clients to read or write the data frame in the memory;
determine if the request is associated with the secure memory region or the unsecure memory region;
determine if the memory client has access privileges to the secure memory region if the request is associated with the secure memory region; and
grant the request if the memory client is determined to have access privileges.

20. The transcoding system of claim 19, further comprising:
a decoder coupled to an input of the controller, the decoder configured to receive a compressed data stream and decode the compressed data stream to supply the data frame.
